(19) United States
(12) Patent Application Publication
(10) Pub. No.: US 2012/0081388 A1
(43) Pub. Date: Apr. 5, 2012

(54) SCALING FOR A LCD BASED UPON VIEWING ANGLE

(75) Inventors: Hao Pan, Camas, WA (US); Xiaofan Feng, Camas, WA (US)

(73) Assignee: SHARP LABORATORIES OF AMERICA, INC., Camas, WA (US)

(21) Appl. No.: 12/894,501

(22) Filed: Sep. 30, 2010

(51) Int. Cl. G09G 5/02

(52) U.S. Cl. 345/596

(57) ABSTRACT

A method for image processing for a liquid crystal display comprising determining a dithered image and an interpolated based upon the image. The images are blended to form a blended image for displaying on the display.

### CROSS-REFERENCE TO RELATED APPLICATIONS

None.

### BACKGROUND OF THE INVENTION

The present invention relates generally to image scaling.

With increasingly higher resolution display devices it is desirable to scale lower resolution input images to the higher resolutions to be displayed on the higher resolution displays. For example, an image having a resolution of 1,000×2,000 pixels should be scaled by a factor of 2 to be suitably displayed on a 2,000×4,000 pixel display. For example, an image having a resolution of 500×1,000 should be scaled by a factor of 4 to be suitably displayed on a 2,000×4,000 pixel display.

Many scaling technique for up converting an image to a higher resolution are interpolation based. Interpolation based techniques fill in the missing pixels by using existing spatial and/or spatial-temporal properties in the input content. For example, the edge-oriented techniques retain the smoothness of edges in the input contents after up-conversion. Other techniques may take advantage of redundant and complimentary information in multiple input frames to achieve both higher spatial resolution and lower noise and artifacts in the up-converted output.

While there has been consistent improvement in the design and manufacturing of liquid crystal displays, they still tend to have viewing angle color dependencies. More specifically, using a normal viewing angle of a displayed image as a reference, there are both color shifts and contrast reductions in the displayed image when viewed from at an off normal angle. The liquid crystal display viewing angle dependency is caused by the fact that the liquid crystal display's transmittance is viewing-angle dependent.

The viewing angle dependency of liquid crystal displays can be decreased by using a dithering technique. The dithering techniques are typically based on the observation that not all gray values' transmittance has the same level of viewing-angle dependence. The dark values and bright gray values' transmittance typically have lower level of viewing-angle dependence than the middle values. Therefore, the liquid crystal display's viewing angle can typically be improved by avoiding using middle gray values when displaying an image. To represent a single pixel, a plurality of proximate pixels are used that generally have an average value consistent with the single pixel. However, using such dithering based techniques tend to significantly reduce the spatial resolution of the display. Moreover, in the high frequency regions of the display the loss of spatial resolution can be especially noticeable.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a scaling system including a dithering module, an interpolation module, an analysis module, a viewer distance module, and blending modules.

FIG. 2 illustrates the spatial scaling.

FIG. 3 illustrates the interpolation module.

FIG. 4 illustrates the dithering module.

FIG. 5 illustrates LCD transmittance.

FIG. 6 illustrates the blending module.

### DETAILED DESCRIPTION OF PREFERRED EMBODIMENT

The resolution of input image content for many digital video discs is 720×480 pixels. While such content does not have as high of resolution as that of blue-ray digital video discs (e.g., 1920×1080 pixel resolution), when displayed on a display the content still looks relatively good to the viewer. In many cases, the image content is up-scaled to a higher resolution matching that of the display, in which case the image has somewhat increased image quality. However, with ever increasing quality displays coupled with relatively good quality input, the increases in visual quality is somewhat limited as a result of up-scaling.

While the viewing angle dependency may tend to decrease somewhat with improvements in display designs, the viewing angle dependency still remains substantial. The increased resolution of the display does not tend to significantly decrease viewing angle dependencies.

It was determined that regions of the image that contain certain characteristics, such as skin-tone regions and regions that are generally uniform, preferably do not undergo significant viewing angle sensitive modifications because modifications of the color in such regions are readily noticeable. Therefore, such regions should be dithered in a suitable manner, thereby reducing the viewing angle dependencies. In contrast, it was determined that regions of the image that contain other characteristics, such as high frequency regions, high texture regions, edge regions, preferably do not undergo substantial dithering because modifications of the spatial resolution of such regions are readily noticeable. Therefore, such regions should be interpolated in a suitable manner, thereby reducing the loss of spatial resolution.

To increase the overall appearance of the display, even if viewing the display from off angle directions, it is desirable to modify the image by dithering regions where the off angle viewing angle derogation is especially noticeable and interpolating regions where the loss of spatial resolution is especially noticeable. Accordingly, the image modification technique should not only consider the spatial, temporal, and/or spatial-temporal properties in the input content, but also consider the liquid crystal displays viewing angle display properties as a result of the input content. Therefore, selective use of interpolation techniques together with dithering techniques should be applied to the input image. In addition, the system may use the visual properties of the viewer, such as the viewing distance to the display, to further modify the scaling applied.

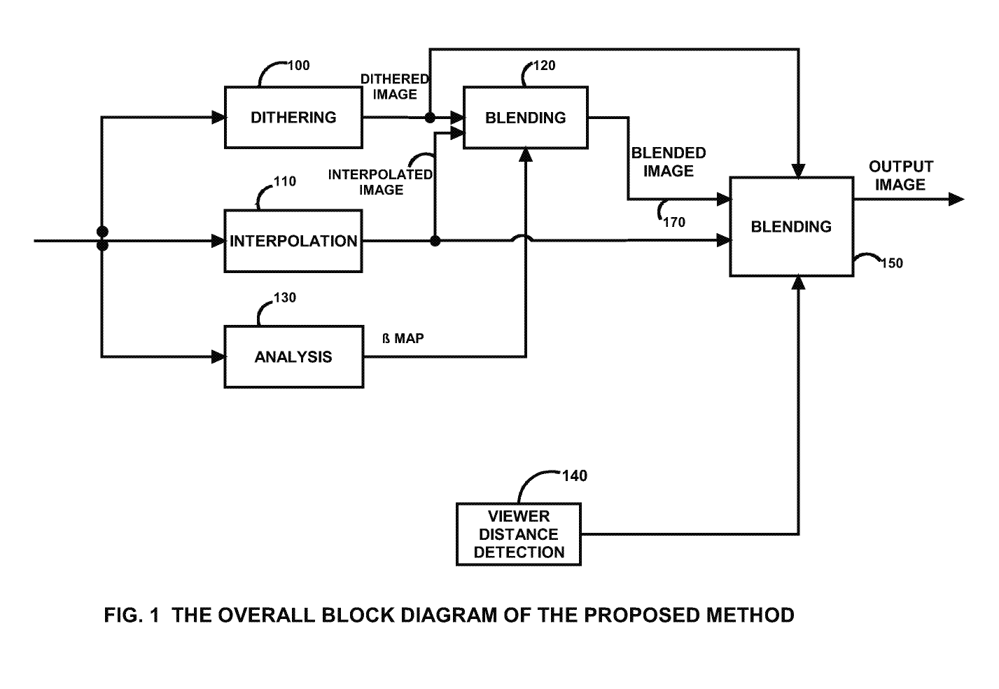

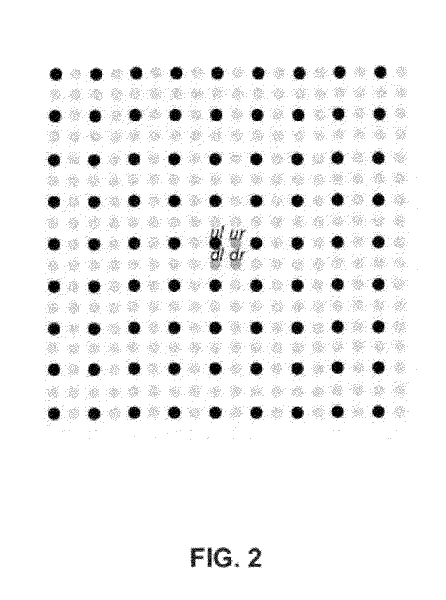

Referring to FIG. 1, a scaling system may include a dithering module 100, an interpolation module 110, a first blending module 120, an analysis module 130, a viewer distance module 140, and a second blending module 150. The interpolation module 110 upscales the input image using any suitable spatial, temporal, and/or spatial-temporal interpolation technique. The interpolation module 110 preferably inputs one pixel of the input image (with the resolution of M×N) and output four pixels ul, ur, dl and dr to the interpolated image (with the resolution of 2M×2N), as illustrated in FIG. 2.

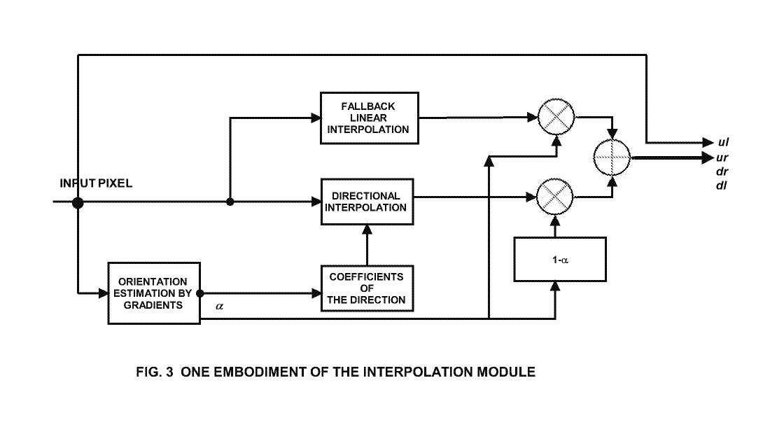

Referring to FIG. 3, one exemplary interpolation technique 110 performs spatial only edge-oriented interpolation. It uses a 5×5 window with the input pixel sitting in the center. In every 5×5 window, the technique estimates the edge orientation of the input pixel based on the luminance Y component, and generates the reliability score α of the estimated edge orientation. Then the technique interpolates three new pixels (ul, ur, dl) along the estimated edge orientation in each of the RGB color channels. The technique uses linear interpolation as the fallback technique. Finally, based on the reliability score α, the above two interpolation results are blended to generate the final four output pixels.

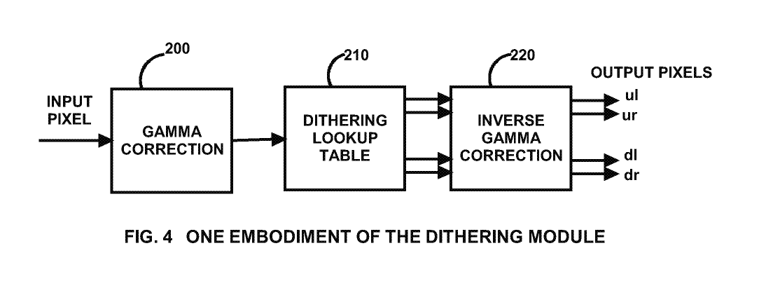

The dithering module 100 modifies the input image using any suitable dithering technique. As illustrated in FIG. 2, the dithering module 100 inputs one pixel of the input image (with the resolution of M×N) and outputs four pixels ul, ur, dl and dr to the dithered image (with the resolution of 2M×2N). An exemplary dithering technique illustrated in FIG. 4 first applies gamma correction 200 to an input pixel to convert it from the gamma based code value domain to the linear domain. Then the pixel is used as a basis for using a lookup table 210 to generate the values of the four pixels at ul, ur, dl, and dr, respectively. Then the four pixels go through an inverse gamma correction 220 to convert back from the linear domain to the gamma based code value domain. The gamma correction 200, the dithering lookup table 210, and the inverse gamma correction 220, may be implemented using three lookup tables, which use display estimates of the target display. The dithering module 100 may likewise operate on multiple input pixels and provide multiple output pixels. In general, the dithering module 100 reduces the spatial resolution while improving the viewing angle.

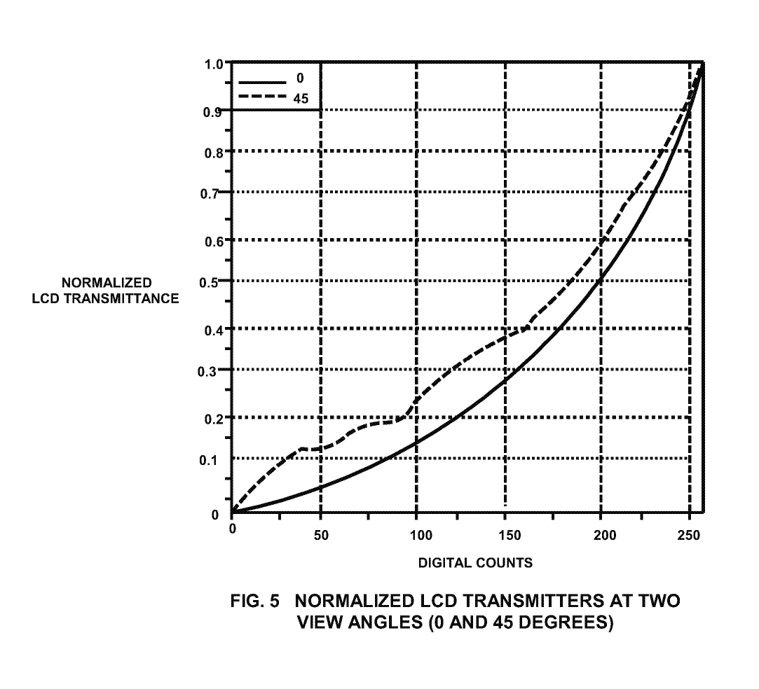

FIG. 5 illustrates the measured and normalized LCD transmittance of a LCD display at two viewing angles, namely, 0 degrees and 45 degrees. The two transmittance curves show that the middle gray values' transmittance is much more viewing angle-dependent than the bright and dark values. Based on this measurement, the dithering lookup table should avoid (or otherwise reduce) using the middle levels in the output pixels. Furthermore, the dithering lookup table may make the mean of the output pixels to be generally the same as the value of input pixel in the linear domain.

The blending module 120 selectively blends the dithered image from the dithering module 100 and the interpolated image from the interpolation module 110 together based on a β map 160 from the image analysis module 130. The blending module 120 inputs one or more pixels of the dithered image (from the dithering module, with the resolution of 2M×2N), one or more pixels of the interpolated image (from the interpolation module, with the resolution of 2M×2N), and a β map 160 (from the analysis module, with the resolution of M×N). The blending module 120 then outputs pixels of the blended image 170 with the resolution of 2M×2N.

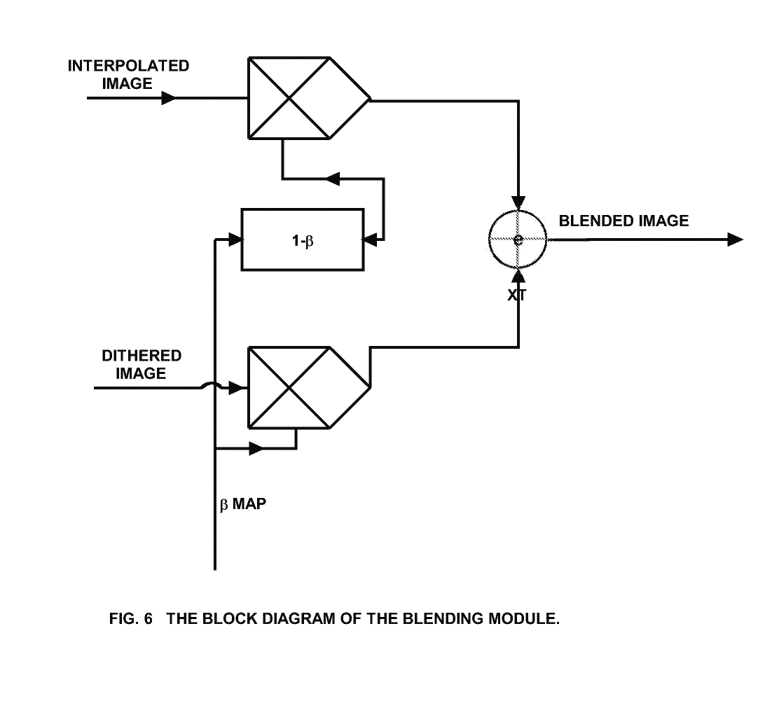

Referring to FIG. 6, an exemplary blending module 120 is illustrated. The technique may be characterized as, image=β*dithered_image+(1-β) *interpolated_image, where β is any value from 0 to 1.

The analysis module 130 analyzes the input image based on features such as colors and gradients, and outputs the β map 160. The β map 160 may have a resolution of M×N, and each β is a scaler between 0 and 1. Between the two extremes, 0 means dithering totally not suitable for up-conversion, and 1 means dithering totally suitable for up-conversion. The β map may be generated using any suitable technique, such as using a skin score map as the β map. Skin score is a suitable measure of β because viewers are sensitive to skin color changes due to the viewing angle changes, and skin regions are typically flat. The skin score may be generated using any suitable technique.

The viewer distance detection module 140 may detect the distance of the viewer to the display. If the viewer is close to the screen it is preferable to avoid or otherwise reduce dithering patterns readily visible to the viewer. The viewer distance detection module outputs a larger value in regions that should have reduced dithering so that the blending module 150 tends to use the interpolated image. If the viewer is not close to the display, the module outputs a low value so that the blending module 150 tends to use the blended image.

In another embodiment, the dithering module may be edge aware. The values at an edge tend to be bright and dark. By selecting values of a dithering pattern that generally match the edge pattern, both the viewing angle will be increased while at the same time maintaining or otherwise not reducing as much the spatial resolution of the image.

The interpolated image and the dithered image may be generated on a pixel by pixel (or otherwise) based upon a blending factor so that the interpolation and blending does not need to be performed for all pixels. Moreover, the interpolation and dithering based upon the blending factor may be done in a single operation.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A method for image processing for a liquid crystal display comprising:
(a) determining a dithered image based upon said image;
(b) determining an interpolated image based upon said image;
(c) blending said dithered image and said interpolated image to form a blended image for displaying on said display.

2. The method of claim 1 wherein said dithered image has a decreased viewing angle dependency.

3. The method of claim 1 wherein said dithered image is applied to different regions of said display.

4. The method of claim 1 wherein said dithered image is not applied to all of said image.

5. The method of claim 1 wherein said interpolated image has less viewing angle dependency than said dithered image.

6. The method of claim 1 wherein said interpolated image is applied to different regions of said display.

7. The method of claim 1 wherein said interpolated image Is not applied to all of said image.

8. The method of claim 1 wherein said determining a dithered image, determining an interpolated image, and said blending is performed in a single operation.

9. The method of claim 1 wherein said determining said interpolated image is based upon only spatial interpolation.

10. The method of claim 1 wherein said determining said interpolated image is based upon only temporal interpolation.

11. The method of claim 1 wherein said determining said interpolated image is based upon only spatial-temporal interpolation.

12. The method of claim 1 wherein said determining said interpolated image is based upon edge based spatial interpolation.

13. The method of claim 1 wherein said determining said dithered image further uses a lookup table.

14. The method of claim 1 wherein said dithered image is further based upon using a dithering pattern corresponding to a respective edge in said image.

15. The method of claim 1 wherein said blending is based upon a scalar value β.

16. The method of claim 15 wherein said blending is based upon said blended image is β times said dithered image *dithered_image+(1-β) times said interpolated image.

17. The method of claim 15 wherein 13 is based upon a skin score.

18. The method of claim 1 wherein said blended image is also based upon a determination of the distance to a viewer of said display.
